(19) United States
(12) Patent Application Publication
(10) Pub. No.: US 2014/0275672 A1
(43) Pub. Date: Sep. 18, 2014

(54) SYSTEMS AND METHODS FOR TEMPORARY DEACTIVATION OF HYDROCRACKING CATALYST

(71) Applicant: KELLOGG BROWN & ROOT LLC, Houston, TX (US)

(72) Inventors: Sujatha Krishnamurthy, Tamil Nadu (IN); Cassandra Schoessow, Pearland, TX (US); Douglas Piotter, Katy, TX (US); Anand Subramanian, Houston, TX (US)

(21) Appl. No.: 14/209,981

(22) Filed: Mar. 13, 2014

Related U.S. Application Data
(60) Provisional application No. 61/783,311, filed on Mar. 14, 2013.

(51) Int. Cl. C10G 1/00; B01J 19/00; C10G 47/02

(52) U.S. Cl. CPC C10G 1/002; C10G 47/02; B01J 19/002
USPC 585/256; 208/60; 422/117; 422/111

(57) ABSTRACT

Methods and systems for idling a hydrocracker are provided. The method can include hydrocracking a hydrocarbon in the presence of a catalyst and hydrogen in a reactor to produce a hydrocracked product. A kill agent can be introduced to the reactor in an amount sufficient to reduce hydrocracking by at least 10% therein. In some examples, the kill agent can include one or more nitrogen-containing compounds, such as ammonia, amines, anilines, ammonia-containing compounds, amine-containing compounds, or, aniline-containing compounds. In some examples, the catalyst can include one or more Group VIII metals (e.g., cobalt, nickel, palladium, iron, alloys thereof), one or more Group VIB metals (e.g., molybdenum, tungsten, alloys thereof, or oxides thereof), and a catalyst support, such as a zeolite.

### CROSS-REFERENCE TO RELATED APPLICATION

This application claims priority to U.S. Provisional Patent Application having Ser. No. 61/783,311, filed Mar. 14, 2013, which is incorporated by reference herein.

### BACKGROUND

1. Field

Embodiments described generally relate to methods and systems for protecting the integrity of a hydrocracking reactor system during a high temperature excursion.

2. Description of the Related Art

Hydrocracking is a catalytic cracking process carried out in the presence of hydrogen. Hydrocracking can produce transportation fuels, such as jet fuel and diesel, and other liquid and/or gaseous hydrocarbon products from higher molecular weight feedstocks. A typical hydrocracking process uses a reactor or vessel in which a higher molecular weight hydrocarbon is contacted with a catalyst in the presence of hydrogen to effect the conversion of the hydrocarbon to more valuable products. The hydrocracking reaction includes a combination of catalytic cracking and hydrogenation. While the catalytic cracking reaction is endothermic, the hydrogenation reaction is exothermic. The heat liberated by the exothermic hydrogenation reaction is typically greater than the heat consumed by the cracking reaction; therefore, the overall hydrocracking process is generally exothermic.

The exothermic nature of the hydrocracking process can result in a sudden unexpected rise in temperature and pressure that can generally increase the reaction rate of the hydrocracking process causing further rise in temperature and pressure that can result in a runaway reaction. Such runaway hydrocracking reaction can result in a rapid increase in temperature and pressure within the reactor and/or downstream equipment, potentially leading to loss of containment of the hydrocracking system. Stopping a runaway hydrocracking reaction is typically a slow process. Runaway hydrocracking reactions are typically addressed by depressurizing the system, cutting off liquid feed to the reactors, and cutting off all feed pre-heating sources. However, hydrocracking processes generally utilize a large inventory of hot feed and lowering the feed rate and temperature of the hydrocracking feed is typically a slow process and an inferior protection against a runaway reaction. In addition, the feedstock and valuable catalysts contained in the reactor are typically destroyed in the process of stopping the runaway reaction.

There is a need, therefore, for improved methods and systems for rapidly shutting down hydrocracking reactions in the event of a runaway reaction without resulting in permanent damage to the catalyst.

### BRIEF DESCRIPTION OF THE DRAWINGS

FIG. 1 depicts a schematic of an illustrative hydrocracking reactor, according to one or more embodiments described.

FIG. 2 depicts the hydrocracking reactor of FIG. 1 having an illustrative kill agent delivery system in fluid communication therewith, according to one or more embodiments described.

FIG. 3 depicts a process schematic employing the hydrocracking reactor of FIG. 1, according to one or more embodiments described.

### DETAILED DESCRIPTION

Methods and systems for idling a hydrocracker are provided. The method can include hydrocracking a hydrocarbon in the presence of a catalyst and hydrogen in a reactor to produce a hydrocracked product. A kill agent can be introduced to the reactor in an amount sufficient to reduce hydrocracking by at least 10% therein.

It has been discovered that a runaway hydrocracking reaction can be controlled or killed by at least partially neutralizing or otherwise decreasing the activity of the hydrocracking catalyst with one or more “kill agents.” By neutralizing the activity of the catalyst, any further reaction and thus temperature rise can be reduced or eliminated. The kill agent can be a temporary catalyst poison, meaning the hydrocracking reactor, including the hydrocracking catalyst, can be returned to operation without the need for catalyst replacement by removing the kill agent therefrom.

The kill agent can include any compound capable of neutralizing the activity of a hydrocracking catalyst. In one or more embodiments, the kill agent can include one or more nitrogen-containing compounds. Exemplary nitrogen-containing compounds that can be kill agents can include, but are not limited to, ammonia, ammonium hydroxide, one or more amines, one or more amides, one or more alkanolamines, one or more aromatic amines, or any mixture thereof. Illustrative alkanolamines can include, but are not limited to, monoethanolamine (“MEA”), diethanolamine (“DEA”), triethanolamine (“TEA”), 2-(2-aminoethoxy)ethanol, aminoethyl ethanolamine, aminobutanol, other aminoalkanols, or any mixture thereof. Illustrative aromatic amines can include, but are not limited to, benzyl amine, aniline, ortho-toluidine, meta-toluidine, para-toluidine, n-methyl aniline, N—N′-dimethyl aniline, diphenyl and triphenyl amines, 1-naphthylamine, 2-naphthylamine, 4-aminophenol, 3-aminophenol, 2-aminophenol, or any mixture thereof. Illustrative polyamines can include, but are not limited to, diethylenetriamine (“DETA”), triethylenetetramine (“TETA”), tetraethylenepentamine (“TEPA”). Other polyamines can include, for example, 1,3-propanediamine, 1,4-butanediamine, polyamidoamines, polyethylenimines, or any mixture thereof.

Other suitable amines can include, but are not limited to, primary amines (“NH₂R₁”), secondary amines (“NHR₁R₂”), and tertiary amines (“NR₁R₂R₃”), where each R₁, R₂, and R₃ can independently be alkyls, cycloalkyls, heterocycloalkyls, aryls, heteroaryls, and substituted aryls. The alkyl can include branched or unbranched alkyls having 1 carbon atom to about 15 carbon atoms or 1 carbon atom to about 8 carbon atoms. Illustrative alkyls can include, but are not limited to, methyl, ethyl, n-propyl, isopropyl, n-butyl, sec-butyl, t-butyl, pentyl, hexyl, ethylhexyl, or isomers thereof. The cycloalkyls can have 3 carbon atoms to about 7 carbon atoms. Illustrative cycloalkyls can include, but are not limited to, cyclopentyl, substituted cyclopentyl, cyclohexyl, and substituted cyclohexyl. The term “aryl” refers to an aromatic substituent containing a single aromatic ring or multiple aromatic rings that are fused together, linked covalently, or linked to a common group such as a methylene or ethylene moiety. More specific aryl groups can include one aromatic ring or two or three fused or linked aromatic rings, e.g., phenyl, naphthyl, biphenyl, anthracenyl, phenanthrenyl, and the like. In one or more embodiments, aryl substituents on the aryl group can have 1 carbon atom to about 20 carbon atoms. The term “heteroatom-containing,” as in a “heteroatom-containing cycloalkyl group,” refers to a molecule or molecular fragment in which one or more carbon atoms is replaced with an atom other than carbon, e.g., nitrogen, oxygen, sulfur, phosphorus, boron, or silicon. Similarly, the term “heteroaryl” refers to an aryl substituent that is heteroatom-containing. The term “substituted,” as in “substituted aryls,” refers to a molecule or molecular fragment in which at least one hydrogen atom bound to a carbon atom is replaced with one or more substituents that are functional groups such as hydroxyl, alkoxy, alkylthio, phosphino, amino, halo, silyl, and the like. Illustrative primary amines can include, but are not limited to, methylamine and ethylamine. Illustrative secondary amines can include, but are not limited to, dimethylamine and diethylamine. Illustrative tertiary amines can include, but are not limited to, trimethylamine and triethylamine. Illustrative amides can include, but are not limited to, acetamide, ethanamide, dicyandiamide, and the like, or any mixture thereof. For example the kill agent can include, ammonia, amine, aniline, one or more ammonia-containing compounds, one or more amine-containing compounds, one or more aniline-containing compounds, or any mixture thereof. In another example, the kill agent can be ammonia. In a further example, the kill agent can be or include urea, uric acid, or a mixture thereof.

The amount of kill agent introduced to a hydrocracking reactor can be sufficient to reduce or stop hydrocracking, e.g., the cracking and/or hydrogenation reactions occurring therein. An excess amount of kill agent, e.g., an amount greater than that necessary to stop cracking and/or hydrogenation can also be used. For example, the amount of kill agent introduced to the hydrocracking reactor can be sufficient to reduce the rate of cracking and/or hydrogenation by about 10%, about 20%, about 30%, about 50%, about 70%, about 80%, about 90%, about 95%, about 98%, about 99%, about 99.9%, about 99.99%, about 99.999%, or 100%. A 99% reduction in the rate of cracking and/or hydrogenation means that cracking and/or hydrogenation is occurring at only 1% of the rate of the cracking and/or hydrogenation that was occurring prior to the introduction of the kill agent. A 100% reduction in the cracking and/or hydrogenation rate means that no cracking and/or hydrogenation is occurring within the hydrocracking reactor.

The kill agent can be introduced to the hydrocracking reactor in any amount. The amount or concentration of the kill agent within the reactor can vary depending, at least in part, on the size of the reactor, the amount of catalyst in the reactor, the desired duration for the hydrocracking interruption or shutdown, and/or any combination thereof. For example, the amount or concentration of the kill agent within the reactor can be at least 0.01 parts per million by weight (“ppmw”), at least 1 ppmw, at least 10 ppmw, at least 100 ppmw, at least 200 ppmw, at least 500 ppmw, at least 1 wt %, at least 2 wt %, at least 3 wt %, at least 4 wt %, at least 5 wt %, at least 7 wt %, at least 8 wt %, at least 9 wt %, at least 10 wt %, at least 12 wt %, at least 14 wt %, about least 16 wt %, at least 18 wt %, or at least 20 wt %, based on the total weight of catalyst in the reactor. In another example, the amount or concentration of the kill agent within the reactor can be about 0.001 wt %, about 0.01 wt %, about 0.1 wt %, about 0.5 wt %, about 1 wt %, about 2 wt %, about 5 wt %, or about 10 wt % to about 25 wt %, about 50 wt %, about 75 wt %, about 90 wt %, or about 99 wt %, based on the total weight of catalyst in the reactor.

The kill agent introduced to the hydrocracking reactor can have a temperature of about −50° C., about −25° C., about 0° C., about 15° C., or about 25° C. to about 45° C., about 100° C., about 250° C., about 400° C., or about 500° C. The kill agent introduced to the hydrocracking reactor can be at a pressure of about 500 kPa, about 1,000 kPa, about 2,000 kPa, about 2,500 kPa, or about 5,000 kPa to about 7,500 kPa, about 10,000 kPa, about 15,000 kPa, about 25,000 kPa, or about 50,000 kPa.

The kill agent can be introduced to the hydrocracking reactor from any location or number of locations within a hydrocracking system. For example, the kill agent can be introduced directly to the hydrocracking reactor, to a hydrocarbon feed line coupled to the hydrocracking reactor, to a hydrogen supply line coupled to the hydrocracking reactor, or any combination thereof. The kill agent can be introduced to the hydrocracking reactor at any location within the reactor. For example, the kill agent can be introduced to the hydrocracking reactor at a location upstream of the catalyst, directly to the catalyst, or any combination thereof. The kill agent can also be delivered to the hydrocracking reactor via one or more quench lines. The quench line can be located at any location or number of locations within the hydrocracking system. For example, the quench lines can be located before, after, and/or between any number of catalyst beds disposed within the hydrocracking reactor.

During operating conditions, these quench lines can deliver hydrogen-containing quench gas to the hydrocracking reactor. Since hydrocracking is an exothermic reaction, hydrogen (with greater thermal conductivity) can be used to cool the one or more catalyst beds therein. This quench gas can also be supplied at temperatures below an operating temperature of the hydrocracking reactor. The kill agent can be admixed with the quench gas. For example, a kill agent source can be coupled to or otherwise in fluid communication with one or more quench lines. The quench line can contain the kill agent diluted in or otherwise mixed with the quench gas and/or an inert carrier, under pressure. The quench gas can include nitrogen, argon, hydrogen, methane, ethane, propane, butane, water, hydrogen sulfide, ammonia, or any mixture thereof. The concentration of kill agent in the quench lines can be about 0.01 wt %, about 0.1 wt %, about 1 wt %, about 5 wt %, about 10 wt %, or about 20 wt % to about 50 wt %, about 60 wt %, about 70 wt %, about 80 wt %, about 90 wt %, about 99 wt %, or 100 wt % kill agent.

The recovery of a hydrocracked product can be adjusted, e.g., reduced, increased and/or stopped, at any time before, after, or at the same time the kill agent can be introduced to the reactor. For example, recovery of the hydrocracked product can be stopped when the kill agent is introduced to the reactor. In another example, the hydrocracked product can be stopped within about +/−5 seconds, +/−10 seconds, +/−30 seconds, +/−1 minute, about +/−5 minutes, or about +/−10 minutes of the time the kill agent is introduced to the reactor.

The rate of reactor feed introduced to the reactor can also be adjusted, e.g., reduced, increased and/or stopped, at any time before, after, or at the same time the kill agent is introduced to the reactor. For example, introduction of the reactor feed can be stopped when the kill agent is introduced to the reactor. In another example, introduction of the reactor feed can be stopped within about +/−5 seconds, +/−10 seconds, +/−30 seconds, +/−1 minute, about +/−5 minutes, or about +/−10 minutes of the time the kill agent is introduced to the reactor.

The flow of particular components of the reactor feed, e.g., one or more hydrocarbon(s), hydrogen, one or more catalyst(s), one or more process gases, and/or one or more inert gases, into the hydrocracking reactor can be stopped at the same time or at different times with respect to one another. For example, all flow of all components of the reactor feed can be stopped at the same time. In another example, flow of the hydrocarbon feed, the hydrogen-containing gas, and/or the one or more catalysts to the reactor can be stopped prior to introduction of the kill agent. In still another example, flow of the hydrocarbon feed, the hydrogen-containing gas, and/or the one or more catalysts to the reactor can be stopped during or after the introduction of the kill agent. This stoppage of flow to the reactor can result in an idle reactor or a shutdown reactor.

Shutting down or idling the reactor can include adjusting the pressure within the reactor. The pressure within the reactor can be adjusted by removing at least a portion of the gases and/or liquids from within the reactor or adding gases and/or liquids to the reactor. For example, the pressure within the reactor can be reduced by venting or purging at least a portion of the gases and/or liquids from within the reactor.

The idling pressure can be less than or greater than the operating pressure. For example, the normal operating pressure within the reactor can be from about 500 kPa, about 1,000 kPa, about 2,000 kPa, about 2,500 kPa, or about 5,000 kPa to about 7,500 kPa, about 10,000 kPa, about 15,000 kPa, about 25,000 kPa, or about 50,000 kPa. After introduction of the kill agent, or during idling, however, the pressure can be reduced to about 50 kPa, about 100 kPa, about 250 kPa, about 500 kPa, or about 750 kPa to about 1,000 kPa, about 1,250 kPa, about 1,500 kPa, about 1,750 kPa, or about 2,000 kPa. The pressure within the reactor can also be reduced by venting or purging at least a portion of any gases and/or liquids within the reactor before, during, or after the kill agent is introduced to the reactor.

If the pressure within the reactor approaches or falls below a desired idling pressure, gases and/or liquids can be introduced to the reactor to increase the pressure therein. For example, nitrogen can be introduced to the reactor to increase the pressure within the reactor to a desired idling pressure. The idling pressure can be less than the operating pressure, equal to the operating pressure, or greater than the operating pressure of the reactor.

The hydrocarbon feed and/or the hydrogen-containing gas can be vented from the reactor and can be introduced to a flare or other disposal system or device and/or storage system or device. If the purge gases are flared, heat can be recovered from the combustion of the hydrocarbons and/or hydrogen-containing gas and can be used, for example, to generate steam. The purged gases can also be stored, for example, in a storage tank for later introduction into the hydrocracking system. The purged gases can also be introduced to a subterranean formation. The purged gases can also be introduced to other refinery processes for the production of one or more chemicals or other products.

The temperature within the reactor can be reduced, before, after, and/or at the same time the kill agent is introduced to the reactor. The idling temperature can be about 400° C. or less, about 100° C. or less, about 50° C. or less, or about 20° C. or less. The temperature within the reactor can be maintained at an idling temperature that can be about ambient or “room” temperature (e.g., about 25° C.) to about 100° C., about 300° C., or about 500° C. Reducing or stopping the cracking and/or hydrogenation within the reactor can reduce or eliminate the heat produced therefrom, which can reduce the temperature within the reactor.

The temperature within the reactor can be reduced before, during, and/or after the introduction of the kill agent to the reactor. The temperature within the reactor before the introduction of the kill agent can be about 100° C., about 200° C., or about 250° C. to about 300° C., about 500° C., or about 750° C. The temperature within the reactor during the introduction of the kill agent can be about 100° C., about 200° C., or about 250° C. to about 300° C., about 500° C., or about 750° C. The temperature within the reactor after introduction of the kill agent can be about 50° C., about 100° C., or about 200° C. to about 300° C., about 350° C., or about 400° C.

The introduction of the kill agent can reduce or maintain the reactor temperature. For example, the introduction of the kill agent can create an idling temperature of about 400° C. or less, about 100° C. or less, about 50° C. or less, or about 20° C. or less after less than 15 minutes, about 10 minutes, or about 5 minutes from introduction of the kill agent to the reactor. The temperature within the reactor can be at an idling temperature that can be about ambient or “room” temperature (e.g., about 25° C.) to about 100° C., about 300° C., or about 500° C. after about 15 minutes, about 10 minutes, or about 5 minutes from introduction of the kill agent to the reactor. Reducing or stopping the cracking and/or hydrogenation within the reactor can reduce or eliminate the heat produced therefrom, which can reduce the temperature within the reactor.

The reactor idling procedure can transition the reactor from an operating state to an idled state, where the reactor can remain idle for any desired period of time. The period of time the reactor can be maintained at or in an idled state can be a few minutes or hours to days or even weeks. For example, the reactor can be maintained in an idled state for a period of time of about 1 hour, about 10 hours, or about 1 day to about 4 days, about 6 days, about 8 days, about 10 days, about 12 days, about 14 days, or about 16 days.

After a period of time for idling the reactor has passed, a reactor restart procedure can be initiated. Restarting the hydrocracking reactor can include reducing the amount or concentration of the kill agent in the hydrocracking reactor to about 50 wt % or less, about 10 wt % or less, about 1 wt % or less, about 0.1 wt % or less, about 100 ppmw or less, about 10 ppmw or less, or about 1 ppmw or less, based on the total weight of catalyst in the reactor. The concentration of the kill agent can be reduced by venting a portion of the quench fluid from the reactor.

In another embodiment, one or more process gases and/or one or more inert gases can be introduced to the reactor to maintain a desired volume of fluid within the hydrocracking system. The process gas and/or inert gas can include, but is not limited to, nitrogen, argon, helium, neon, hydrogen, or any mixture thereof. The reactor feed, including the hydrocarbon feed and the hydrogen-containing gas, can be introduced in addition to or in lieu of the process gases or the inert gases.

Once introduction of the feed has been restarted and hydrocracking has been restarted, hydrocracked product recovery can be restarted. The rate of product recovery can be less than the normal operating rate and can increase as the amount of hydrocracked product increases. The yield of hydrocracked product can increase as the rate of introducing the hydrogen-containing gas and the hydrocarbon feed increases. The yield of hydrocracked product can also be increased as the concentration of kill agent within the reactor is reduced and/or eliminated.

The time required to restart the reactor from idling to normal operating conditions can be about 1 minute, about 5 minutes, about 10 minutes, or about 20 minutes to about 30 minutes, about 45 minutes, about 1 hour, about 2 hours, about 10 hours, about 24 hours, or about 72 hours. Restarting the reactor can begin upon correction or termination of one or more shutdown indicators. For example, if the shutdown indicator was a malfunction of a discharge tank, termination of the shutdown indicator could occur once the malfunction of the discharge is corrected. However, after correction of any shutdown indicator(s) the hydrocracking system can continue to remain in an idled state for any desired period of time.

FIG. 1 depicts a schematic of an illustrative hydrocracking reactor 104, according to one or more embodiments. The hydrocracking reactor 104 can be in fluid communication with one or more hydrocarbon feed lines 102, one or more hydrogen feed lines 103, one or more quench lines 114, 115, and one or more hydrocracked product lines 106. The hydrocracking reactor 104 can include a vessel having a first end or top end, a second end or bottom end, and one or more sidewalls containing one or more catalyst beds 108, 109, and 110. One or more hydrocarbons via line 102 and hydrogen via line 103 can be introduced to the hydrocracking reactor 104 via a feed line 112 coupled to the hydrocracking reactor 104. The hydrocarbon can be cracked within the hydrocracking reactor 104 in the presence of the catalyst beds 108, 109, and 110 under conditions sufficient to form a cracked product. The cracked product recovered via line 106 can be or include naphtha, diesel, jet fuel, kerosene, gasoline, C₁-C₄ hydrocarbons, gas oil, or any mixture thereof.

The hydrocarbon or feed in line 102 can be or include any hydrocarbon having one or more carbon atoms. For example, the hydrocarbon in line 102 can include C₂-C₅₀ hydrocarbons, C₂-C₄₀ hydrocarbons, C₃-C₃₀ hydrocarbons, or C₄-C₂₀ hydrocarbons. The hydrocarbon in line 102 can be one or more heavy and/or low value hydrocarbons. For example, the hydrocarbon in line 102 can include C₁₂+ hydrocarbons, such as C₁₂₋₅₀ hydrocarbons. The hydrocarbon in line 102 can include, but is not limited to, whole crude oil, crude oil, vacuum gas oil, heavy gas oil, residuum, atmospheric tower bottoms, vacuum tower bottoms, distillates, paraffins, aromatic rich material from solvent deasphalting units, visbroken resids, aromatic hydrocarbons, naphthenes, oil shales, oil sands, tars, bitumens, kerogen, coal liquids, waste oils, fractions thereof, and mixtures hereof.

The hydrocarbon in line 102 can have an API Gravity at 15.6° C., measured in accordance with ASTM D287, of about −12, about 0, about 5, or about 10 to about 20, about 25, about 30, or about 35. For example, the hydrocarbon in line 102 can have an API Gravity at 15.6° C. of about −12 to about 20, or about 5 to about 23, or about 10 to about 30. The paraffin content of the hydrocarbon in line 102 can be about 30 wt %, about 35 wt %, or about 40 wt % to about 55 wt %, about 60 wt %, or about 65 wt %. The aromatic hydrocarbon content of the hydrocarbon in line 102 can be about 2 wt %, about 7 wt %, or about 12 wt % to about 20 wt %, about 50 wt %, or about 80 wt %. The naphthene content of the hydrocarbon in line 102 can be about 0 wt %, about 10 wt %, or about 20 wt % to about 25 wt %, about 30 wt %, or about 35 wt %. The hydrocarbon in line 102 can have a C:H ratio of about 0.8:1, about 1:1, about 1:1.1, about 1:1.2, about 1:1.3, or about 1:1.4. The hydrocarbon in line 102 can have a hydrogen content of about 3 wt %, about 6 wt %, or about 9 wt % to about 12 wt %, about 15 wt %, or about 20 wt %, based on the total weight of the hydrocarbon.

In one or more embodiments, the hydrocarbon in line 102 can be a light hydrocarbon limited to hydrocarbons having about 12 carbon atoms or less. For example, the hydrocarbon in line 102 can include C₂-C₁₀ hydrocarbons. Examples of suitable hydrocarbons can include, but are not limited to, paraffinic, cycloparaffinic, monoolefinic, diolefinic, cycloolefinic, naphthenic, and aromatic hydrocarbons, and hydrocarbon oxygenates. The hydrocarbon in line 102 can include light paraffinic naphtha; heavy paraffinic naphtha; light olefinic naphtha; heavy olefinic naphtha; mixed paraffinic C₄ hydrocarbons; mixed olefinic C₄ hydrocarbons (e.g., raffinates); diolefins (e.g., butadiene); mixed paraffinic C₅ hydrocarbons; mixed olefinic C₅ hydrocarbons (e.g., raffinates); mixed paraffinic and cycloparaffinic C₆ hydrocarbons; non-aromatic fractions from an aromatics extraction unit; oxygenate-containing products from a Fischer-Tropsch unit; or the like; or any mixture thereof. Hydrocarbon oxygenates can include alcohols having 1 carbon atom to about 4 carbon atoms and ethers having 2 carbon atoms to about 8 carbon atoms. Examples include, but are not limited to, methanol, ethanol, dimethyl ether, methyl tertiary butyl ether (MTBE), ethyl tertiary butyl ether, tertiary amyl methyl ether (TAME), tertiary amyl ethyl ether, or any mixture thereof.

As used herein, the term “light” in reference to feedstock or hydrocarbons generally refers to hydrocarbons having 12 carbon atoms or less, such as about 10 carbon atoms or less. The term “heavy” in reference to feedstock or hydrocarbons generally refers to hydrocarbons having more than 12 carbon atoms. In one or more embodiments, the light hydrocarbon can have 1 carbon atom to 12 carbon atoms, 1 carbon atom to about 10 carbon atoms, 1 carbon atom to about 8 carbon atoms, 1 carbon atom to about 6 carbon atoms, 1 carbon atom to about 4 carbon atoms. In one or more embodiments, the light hydrocarbon can include one or more C₂-C₈ hydrocarbons, or C₂-C₁₀ hydrocarbons, or C₂-C₁₂ hydrocarbons. The terms “naphtha” or “full range naphtha,” as used herein, refer to a hydrocarbon mixture having a 10 percent point below 60° C. and a 95 percent point below 240° C. as determined by distillation in accordance with the standard method of ASTM-D86; “light naphtha” to a naphtha fraction with a boiling range of C₄ to 166° C.; and “heavy naphtha” to a naphtha fraction with a boiling range of 166° C. to 211° C. As used herein, the term “paraffinic” in reference to a hydrocarbon or feed refers to a light hydrocarbon mixture including at least 80 wt % paraffins, no more than 10 wt % aromatics, and no more than 40 wt % cycloparaffins. As used herein, the term “aromatic” in reference to a hydrocarbon or feed refers to a light hydrocarbon mixture including more than 50 wt % aromatics. As used herein, the term “olefinic” in reference to a hydrocarbon or feed refers to a light hydrocarbon mixture including at least 20 wt % olefins. As used herein, the term “mixed C₄'s” in reference to a hydrocarbon or feed refers to a light hydrocarbon mixture including at least 90 wt % of hydrocarbon compounds having about 4 carbon atoms.

The hydrocarbon in line 102 can include C₂-C₁₀ hydrocarbons in an amount of about 20 wt %, about 30 wt %, or about 40 wt % to about 80 wt %, about 90 wt %, or about 100 wt %. For example, the hydrocarbon in line 102 can have a C₂-C₁₀ hydrocarbon concentration of about 20 wt % to about 100 wt %, about 30 wt % to about 99.9 wt %, about 60 wt % to about 99 wt %, about 85 wt % to about 99 wt %, or about 95 wt % to about 100 wt %. The hydrocarbon in line 102 can include C₄-C₈ hydrocarbons in an amount of about 10 wt %, about 20 wt %, or about 30 wt % to about 70 wt %, about 80 wt %, or about 100 wt %. For example, the hydrocarbon in line 102 can have a C₄-C₈ hydrocarbon concentration of about 60 wt % to about 100 wt %, about 70 wt % to about 100 wt %, about 80 wt % to about 100 wt %, or about 90 wt % to about 100 wt %. The hydrocarbon in line 102 can have less than 50 wt %, about 20 wt %, about 10 wt %, about 5 wt %, about 1 wt %, about 0.1 wt %, or about 0.01 wt % C₁₁+ hydrocarbons. The hydrocarbon in line 102 can have less than 60 wt %, about 30 wt %, about 15 wt %, about 10 wt %, about 5 wt %, about 1 wt %, or about 0.1 wt % C₉+ hydrocarbons.

The hydrocarbon in line 102 can include one or more olefins in an amount of about 0.01 wt %, about 10 wt %, or about 20 wt % to about 50 wt %, about 75 wt %, or about 100 wt %. For example, the hydrocarbon in line 102 can have an olefin concentration of about 0.1 wt % to about 99.9 wt %, about 10 wt % to about 75 wt %, or about 20 wt % to about 50 wt %. The hydrocarbon in line 102 can include one or more C₄ olefins in an amount from of about 0.01 wt %, about 1 wt %, or about 10 wt % to about 20 wt %, about 40 wt %, or about 100 wt %. For example, the hydrocarbon in line 102 can have a C₄ olefin concentration of about 0.1 wt % to about 99.9 wt %, about 1 wt % to about 30 wt %, or about 5 wt % to about 15 wt %. The hydrocarbon in line 102 can include one or more dienes in an amount of about 0.01 wt %, about 0.1 wt %, or about 1 wt % to about 10 wt %, about 20 wt %, or about 40 wt %. For example, the hydrocarbon in line 102 can have a diene concentration of about 1 wt % to about 25 wt %, about 0.1 wt % to about 10 wt %, or about 1 wt % to about 5 wt %. In one or more embodiments, the hydrocarbon in line 102 can include one or more dienes in an amount of less than 40 wt %, less than 10 wt %, less than 1 wt %, or less than 0.1 wt %.

In one or more embodiments, the hydrocarbon in line 102 can consist essentially of light hydrocarbons. In one or more embodiments, the hydrocarbon in line 102 can include, but is not limited to, one or more C₄-containing compounds such as butane (e.g., “n-butane”) and isobutane. In one or more embodiments, the hydrocarbon can be a refinery off-gas resulting from the distillation of crude oil. In one or more embodiments, the hydrocarbon in line 102 can include about 1 wt % to 5 wt % methane, about 1 wt % to about 10 wt % ethane, about 1 wt % to about 30 wt % propane, about 1 wt % to about 35 wt % butane, and about 1 wt % to about 20 wt % heavier hydrocarbons.

The amount of hydrocarbon introduced via line 102 to the hydrocracking reactor 104 can vary widely and can depend, at least in part, on the particular size of the reactor, the type of feed, the particular catalyst, and the like. For example, the hydrocarbon feed in line 102 can have a hydrocarbon flow rate of about 0.1 kilogram per hour (kg/hr), about 1 kg/hr, about 10 kg/hr, about 100 kg/hr, or about 1,000 kg/hr to about 50,000 kg/hr, about 100,000 kg/hr, about 250,000 kg/hr, about 500,000 kg/hr, or about 1,500,000 kg/hr. The hydrocarbon feed in line 102 can be at a temperature of about 20° C., about 50° C., about 75° C., about 100° C., or about 125° C. to about 150° C., about 200° C., about 300° C., about 500° C., or about 750° C. The hydrocarbon feed in line 102 can have pressures of about 500 kPa, about 1,000 kPa, about 2,000 kPa, about 2,500 kPa, or about 5,000 kPa to about 7,500 kPa, about 10,000 kPa, about 15,000 kPa, about 25,000 kPa, or about 50,000 kPa.

The hydrocarbon feed in line 102 can be in or include a solid, liquid, and/or vapor phase. For example, the hydrocarbon feed in line 102 can be at least 50 vol %, about 75 vol %, about 80 vol %, about 85 vol %, about 95 vol %, about 99 vol % liquid phase. In another example, the hydrocarbon feed in line 102 can be at least 50 vol %, about 75 vol %, about 80 vol %, about 85 vol %, about 95 vol %, about 99 vol % vapor phase. In another example, the hydrocarbon feed in line 102 can be 100 vol % liquid phase or 100 vol % vapor phase.

The hydrogen via line 103 can be introduced to the hydrocracking reactor 104 as a hydrogen-containing gas, pure hydrogen gas or in the form a mixture of hydrogen and one or more other gases. For example, a hydrogen-containing gas via line 103 introduced to the hydrocracking reactor 104 can contain a concentration of hydrogen (H₂) of about 50 vol % or greater, about 65 vol % or greater, about 75 vol % or greater, about 85 vol % or greater, or about 95 vol % or greater. The hydrogen-containing gas via line 103 can include, but is not limited to, other components that can be found in a refinery-grade hydrogen gas, such as carbon monoxide, carbon dioxide, methane, ethane, and hydrogen sulfide. In some examples, the hydrogen-containing gas via line 103 can contain a concentration of hydrogen sulfide of about 3 mol % or less, about 1 mol % or less, about 0.1 mol % or less, or about 0.01 mol % or less. The hydrocarbon feed in line 102 and the hydrogen-containing gas via line 103 can be combined or mixed to form a mixed feed or hydrocracker feed in the feed line 112. In one or more embodiments (not shown), the hydrocarbon feed in line 102 and the hydrogen-containing gas in line 103 can be separately or independently introduced to the hydrocracking reactor 104.

The reactor vessel or hydrocracking reactor 104 can include one or more catalyst beds in any arrangement, configuration and/or orientation. The one or more catalyst beds can include fixed beds, fluidized beds, ebullating beds, slurry beds, moving beds, bubbling beds, any other suitable type of catalyst bed, or combinations thereof. The hydrocracking reactor 104 can be configured vertically for upward or downward flow through the one or more catalyst beds, or horizontally for lateral flow through the one or more catalyst beds. The one or more catalyst beds can be axial beds, axial/radial beds, radial beds, or any combination thereof. The one or more catalyst beds can be cold gas quenched, inter-cooled using one or more exchangers, or a combination thereof to control or otherwise regulate the temperature of the one or more catalyst beds. In at least one specific embodiment (not shown), the hydrocracking reactor 104 can include a single hydrocracking stage, e.g., a single catalyst bed. In an example, as shown in FIG. 1, the hydrocracking reactor 104 can include a first catalyst bed 108, a second catalyst bed 109, and a third catalyst bed 110. The catalyst in the first, second, and third catalyst beds 108, 109, and 110 can be the same or different with respect to one another.

The catalyst in the first catalyst bed 108, the second catalyst bed 109, and/or the third catalyst bed 110 can include any suitable catalyst or combination of catalysts for cracking hydrocarbons and/or hydrogenating hydrocarbons. The catalyst can include, but is not limited to, one or more metals or elements of Group VIII of the Periodic Table of Elements, such as iron, ruthenium, osmium, cobalt, rhodium, iridium, nickel, palladium, platinum, alloys thereof, or combinations thereof. The catalyst can be combined with one or more metals or elements of Groups VIB, IA, HA, and/or IB of the Periodic Table of Elements, such as chromium, molybdenum, tungsten, chromium oxide, molybdenum oxide, tungsten oxide, lithium, sodium, potassium, rubidium, cesium, beryllium, magnesium, calcium, strontium, copper, silver, gold, oxides thereof, alloys thereof, or combinations thereof. The catalyst can be supported by, or otherwise disposed on, a catalyst support. Illustrative catalyst supports can include, but are not limited to, alumina, silica-alumina, silica, titania, zirconia, titania-zirconia, hafnia, or combination or mixture thereof.

As used herein, all reference to the Periodic Table of the Elements and Groups thereof is to the New Notation published in “Hawley's Condensed Chemical Dictionary,” Thirteenth Edition, John Wiley & Sons, Inc., (1997) (reproduced there with permission from IUPAC), unless reference is made to the Previous IUPAC form noted with Groups designated by Roman numerals (also appearing in the same), or unless otherwise noted. For example, as used herein, Group VIII is a reference to the Previous IUPAC system and is equivalent to Groups 8, 9 and 10 under the modern IUPAC system, Group VIB is a reference to the Previous IUPAC system and is equivalent to Group 6 under the modem IUPAC system, and Groups IA, IIA, and IB are a reference to the Previous IUPAC system and is equivalent to Groups 1, 2, and 11, respectively, under the modem IUPAC system.

The catalyst can utilize amorphous bases or low-level zeolite bases combined with one or more metal hydrogenating components containing one or more metals of one or more elements of Group VIII or Group VIB. The catalyst can include any acidic silica-alumina or crystalline zeolite cracking base upon which can be deposited, formed, or otherwise disposed on a minor proportion of a Group VIII metal hydrogenating component containing one or more metals or alloys of Group VIII metals (e.g., Fe, Ru, Os, Co, Rh, Ir, Ni, Pd, or Pt). Additional hydrogenating components can include one or more Group VIB metals, alloys, or metal oxides (e.g., Cr, Mo, W, or oxides thereof) for incorporation with the zeolite base. The zeolite cracking bases, such as molecular sieves, can be composed of or can contain silica, alumina, and/or one or more exchangeable cations, such as lithium, sodium, potassium, beryllium, magnesium, calcium, or mixtures thereof. The zeolites can further be characterized by crystal pores of relatively uniform diameter of about 4 Å to about 16 Å, about 6 Å to about 14 Å, or about 8 Å to about 12 Å. The zeolite cracking bases can have a silica/alumina mole ratio of about 2 to about 12, about 3 to about 10, or about 4 to about 6. The catalyst can include naturally occurring zeolites and/or synthetic zeolites. Exemplary zeolites that are naturally occurring can include, but are not limited to, mordenite, stilbite, heulandite, ferrierite, dachiardite, chabazite, erionite, and faujasite. Exemplary synthetic zeolites can include, but are not limited to, the B, X, Y, and L crystal types, e.g., synthetic faujasite and mordenite. For example, the zeolite can be a Y-type zeolite.

The zeolite can include a zeolite molecular sieve having a macroporous structure, such as, a zeolite molecular sieve having a faujasite structure or a Beta zeolite structure; a zeolite molecular sieve having a mesoporous or mesopore structure, such as a zeolite molecular sieve having a mordenite structure, a ZSM-5 zeolite structure, a ZSM-11 zeolite structure, a ZSM-22 zeolite structure, a ZSM-23 zeolite structure, a ZSM-35 zeolite structure, a ZSM-48 zeolite structure, or a ZSM-57 zeolite structure; or a zeolite molecular sieve having a micropore structure, such as a zeolite molecular sieve having an Erionite zeolite structure or a ZSM-34 zeolite structure. In an example, the zeolite molecular sieve can include one or more of a zeolite molecular sieve having a faujasite structure, a zeolite molecular sieve having a Beta zeolite structure, a zeolite molecular sieve having a ZSM-5 zeolite structure and a zeolite molecular sieve having a mordenite structure. The Y-type zeolite can be one or more of a HY-zeolite molecular sieve, a rare earth type Y-zeolite (REY) molecular sieve, a rare earth type HY-zeolite (REHY) molecular sieve, a superstable Y-zeolite (USY) molecular sieve, a rare-earth type superstable Y-zeolite (REUSY) molecular sieve, a phosphor-containing Y-zeolite molecular sieve, a phosphor-containing Y-superstable zeolite molecular sieve, a phosphor-containing HY-zeolite molecular sieve, a dealuminized Y-zeolite molecular sieve, and the like.

Active metals employed in the hydrocracking catalysts as hydrogenation components can include Group VIII metals (e.g., Fe, Ru, Os, Co, Rh, Ir, Ni, Pd, Pt, alloys thereof, or combinations thereof). In addition to these metals, other promoters can also be employed in conjunction therewith, including the Group VIB metals (e.g., Cr, Mo, W, oxides thereof, alloys thereof, or combinations thereof). The amount of active metal in the catalyst can vary in any amount. For example, the amount of active metal in the catalyst can be about 0.05 wt %, about 0.1 wt %, about 1 wt %, about 2 wt %, or about 5 wt % to about 8 wt %, about 10 wt %, about 15 wt %, about 20 wt %, or about 30 wt %, based on the total weight of the catalyst. When the active metal is a noble metal, the amount of hydrogenating metal in the catalyst can be about 0.01 wt %, about 0.05 wt %, about 0.1 wt %, about 0.2 wt %, or about 0.3 wt % to about 0.5 wt %, about 1 wt %, about 2 wt %, about 3 wt %, or about 5 wt %, based on the total weight of the catalyst.

The operating temperature of the hydrocracking reactor 104 before introduction of the kill agent can be about 200° C., about 250° C., or about 300° C. to about 400° C., about 500° C., or about 600° C. For example, the operating temperature of the hydrocracking reactor 104 before introduction of the kill agent can be at a temperature of about 100° C. to about 750° C. or about 275° C. to about 450° C. The operating pressure of the hydrocracking reactor 104 before introduction of the kill agent can be at a pressure of about 500 kPa, about 1,000 kPa, about 2,000 kPa, about 2,500 kPa, or about 5,000 kPa to about 7,500 kPa, about 10,000 kPa, about 15,000 kPa, about 25,000 kPa, or about 50,000 kPa. For example, the operating pressure of the hydrocracking reactor 104 before introduction of the kill agent can be about 2,000 kPa to about 40,000 kPa or about 7,000 kPa to about 12,000 kPa. The hydrocracking reactor 104 before introduction of the kill agent can be operated with a liquid hourly space velocity (LHSV) of about 0.1 per hour (/hr), about 0.5/hr, or about 1/hr to about 5/hr, about 10/hr, or about 15/hr. For example, the LHSV of the hydrocracking reactor before introduction of the kill agent can be about 0.2/hr to about 12/hr, about 2/hr to about 8/hr, or about 4/hr to about 6/hr.

Before introduction of the kill agent, the hydrocracked product recovered via line 106 can contain at least 10 wt %, at least 50 wt %, at least 75 wt %, or at least 99 wt % total cracked hydrocarbons. The hydrocracked product via line 106 can contain at least 0.01 wt %, at least 1 wt %, at least 10 wt %, at least 20 wt %, or at least 50 wt % full range naphtha before introduction of the kill agent. The hydrocracked product via line 106 can contain at least 0.01 wt %, at least 1 wt %, at least 10 wt %, at least 20 wt %, at least 50 wt %, or at least 75 wt % diesel before introduction of the kill agent. The hydrocracked product via line 106 can contain at least 0.01 wt %, at least 1 wt %, at least 10 wt %, at least 20 wt %, at least 50 wt %, or at least 75 wt % gas oil before introduction of the kill agent.

To initiate a kill sequence of the hydrocracking reaction, the kill agent as described herein can be introduced to the hydrocracking reactor 104 via the quench lines 114 and/or 115, for example. The quench lines 114, 115 are shown in FIG. 1 as being coupled to the hydrocracking reactor 104 at locations on the hydrocracking reactor 104 downstream of hydrocracking catalyst beds 108, 109, respectively. In other embodiments (not shown), the quench lines 114, 115 can be coupled to the hydrocracking reactor 104 at any location(s) on the hydrocracking reactor 104 including at or upstream of hydrocracking catalyst beds 108, 109 such that the kill agent is introduced upstream of or directly to the hydrocracking catalyst beds 108, 109.

In one or more embodiments, the kill agent can be delivered by a kill agent delivery system (not shown). The kill agent delivery system can include one or more valves (not shown) each disposed on one or more separate kill agent delivery lines (not shown). The kill agent delivery lines 114, 115 can be in fluid communication with a kill agent source (not shown), such as a storage tank or vessel containing the kill agent, for example an amine drum. During hydrocracking operation, the one or more valves can remain closed. Upon the initiation of an event, such as a sudden increase in temperature and/or pressure of the hydrocracking reactor 104, at least one of the one or more valves can open, releasing kill agent into the hydrocracking reactor 104. The kill agent can also be delivered to the hydrocracking reactor with one or more pumps (not shown) in fluid communication with the kill agent delivered via the quench lines 114, 115. The one or more valves and/or one or more pumps can be manually and/or remotely activated to permit and/or prevent fluid flow therethrough. For example, the one or more valves can be manually opened and closed by operators or users on site. In another example, the one or more valves and/or one or more pumps can be linked to a control system and can be opened and closed, or activated, from a remote location, such as a control room or other facility (not shown).

Contacting of the catalyst surface with the kill agent can include at least partially wetting or completely wetting the catalyst surface with the kill agent. The contacting and/or wetting of a catalyst surface with the kill agent can reduce the activity of the catalyst. For example, contacting the catalyst surface with the kill agent can reduce the activity of the catalyst by at least 1%, at least 50%, or at least 99%. In an example, contacting the catalyst surface with the kill agent can reduce the activity of the catalyst by about 90% to about 10%, about 80% to about 20%, or about 60% to about 40%. In another example, contacting the catalyst surface with the kill agent can completely stop the activity of the catalyst.

Introduction of the kill agent via the quench lines 114, 115, as discussed and described, above can allow the kill agent to pass through existing quench gas distributors (not shown) to ensure a complete wetting or covering of the catalyst bed(s) with the kill agent. In an example, an amount of the total surface area of each catalyst bed 109, 110 that can be wetted by the kill agent can be at least 10%, at least 20%, at least 30%, at least 40%, at least 50%, at least 60%, at least 70%, at least 80%, at least 90%, at least 95%, or at least 99%. For example, the amount of the catalyst surface area of each catalyst bed 109, 110 that can be wetted can be about 10% to about 100%, about 30% to about 99%, or about 70% to about 95% once the kill agent has been introduced to the hydrocracking reactor 104. In another example, the amount of the catalyst surface area of at least one of the catalyst beds 109, 110 that can be wetted can be 100%.

In another example, an amount of the total surface area of each catalyst bed 108, 109 that can be wetted by the kill agent can be at least 10%, at least 20%, at least 30%, at least 40%, at least 50%, at least 60%, at least 70%, at least 80%, at least 90%, at least 95%, or at least 99%. For example, the amount of the total surface area of each catalyst bed 108, 109 that can be wetted can be about 10% to about 100%, about 30% to about 99%, or about 70% to about 95% once the kill agent has been introduced to the hydrocracking reactor 104. In a further example (not shown), an amount of a total surface area of each catalyst bed 108, 109, and 110 that can be wetted by the kill agent can be at least 10%, at least 20%, at least 30%, at least 40%, at least 50%, at least 60%, at least 70%, at least 80%, at least 90%, at least 95%, or at least 99%. For example, the amount of the total surface area of each of the catalyst beds 108, 109, and 110 that can independently be wetted can be about 10% to about 100%, about 30% to about 99%, or about 70% to about 95% once the kill agent has been introduced to the hydrocracking reactor 104.

The process conditions of the hydrocracking reactor 104 can be adjusted to idling conditions after about 120 minutes or less, about 60 minutes or less, about 30 minutes or less, or about 1 minute or less from introduction of the kill agent to the hydrocracking reactor 104. The concentration of the kill agent can be reduced by venting fluid from the hydrocracking reactor 104. One of more process gases and/or one or more inert gases can be introduced to the hydrocracking reactor to maintain a desired volume of fluid within the hydrocracking system. The reactor feed, including the hydrocarbon feed and the hydrogen-containing gas, can be introduced in addition to or in lieu of the process gases or the inert gases. Once introduction of the feed has been restarted and hydrocracking has been returned to operating conditions, the hydrocracked product recovery can be restarted.

After restarting the hydrocracking reactor 104, the hydrocracked product recovered via line 106 can contain at least 10 wt %, at least 50 wt %, at least 75 wt %, or at least 99 wt % total cracked hydrocarbons. The hydrocracked product via line 106 can contain at least 0.01 wt %, at least 1 wt %, at least 10 wt %, at least 20 wt %, or at least 50 wt % full range naphtha after restarting the hydrocracking reactor 104. The hydrocracked product via line 106 can contain at least 0.01 wt %, at least 1 wt %, at least 10 wt %, at least 20 wt %, at least 50 wt %, or at least 75 wt % diesel after restarting the hydrocracking reactor 104. The hydrocracked product via line 106 can contain at least 0.01 wt %, at least 1 wt %, at least 10 wt %, at least 20 wt %, at least 50 wt %, or at least 75 wt % gas oil after restarting the hydrocracking reactor 104.

FIG. 2 depicts the hydrocracking reactor 104 having an illustrative kill agent delivery system in fluid communication therewith, according to one or more embodiments. The quench lines 114, 115 can be existing quench lines used to deliver hydrogen-containing quench gas to the hydrocracking reactor 104. The kill agent can be admixed with the quench gas to be delivered to the hydrocracking reactor 104 via the quench lines 114, 115. For example, a kill agent source or kill agent vessel 204, such as an amine drum or storage container, can be coupled to or otherwise in fluid communication with the quench lines 114, 115.

A pressurized quench gas via a quench source line 201 can split to form a main or primary quench line 203 and a secondary quench line 202. The pressured quench gas via the quench source line 201 can be introduced to the kill agent vessel 204 via the secondary quench line 202. The secondary quench line 202 can be coupled to the kill agent vessel 204 at any location on the kill agent vessel 204. For example, the secondary quench line 202 can be coupled to a bottom, a top, or at any location along a sidewall of the kill agent vessel 204. As shown in FIG. 2, the secondary quench line 202 can be coupled to the top of the kill agent vessel 204. One or more kill agent introduction lines can also be coupled to the kill agent vessel 204 at any location on the kill agent vessel 204. For example, the kill agent introduction line can be coupled to a bottom, a top, or at any location along a sidewall of the kill agent vessel 204. A first kill agent introduction line 206 can be coupled to the bottom of the kill agent vessel 204 and a second kill agent introduction line 210 can be coupled to the quench line 114. The first kill agent introduction line 206 and the second kill agent introduction line 210 can be joined or fluidly coupled by one or more isolation valves 208.

The kill agent can be held under pressure by a stream of the quench gas via the secondary quench line 202 and can be fluidly isolated from the hydrocracking process by means of the isolation valve 208 to ensure activity of the catalyst is not lost or reduced as a result of contacting the kill agent during normal operation of the hydrocracking reactor 104. In the event of a sudden rise in temperature and/or pressure in the hydrocracking reactor 104, for example, the isolation valve 208 can open, releasing kill agent into the second kill agent introduction line 210 and thus into the quench line 114. The quench gas via line 202, which can be coupled to the top of the kill agent vessel 204, can flow through the kill agent vessel 204, thus enabling the kill agent contained in the kill agent vessel 204 to be introduced to the hydrocracking reactor 104. This embodiment can allow the kill agent to be quickly injected or dumped into the hydrocracking reactor 104 with limited back flow of the kill agent back into line 201. A quench gas valve 205 can be disposed or added between the quench line 114 and the main quench line 203. The closing of the quench gas valve 205 can increase the flow and/or pressure of the quench gas in the secondary quench line 202. The closing of the quench gas valve 205 can also limit back flow of the kill agent back into line 201.

The isolation valve 208 and/or the quench gas valve 205 can each be manually and/or remotely activated to permit and/or prevent fluid flow therethrough. For example, the isolation valve 208 and/or the quench gas valve 205 can be manually opened and closed by operators or users on site. In another example, the isolation valve 208 and/or the quench gas valve 205 can be linked to a control system and can be opened and closed, or activated, from a remote location, such as a control room or other facility (not shown).

A condition or instruction can initiate the kill sequence as disclosed above. For example, one or more hydrocracking reaction conditions occurring within the hydrocracking reactor 104 can approach or exceed one or more set or predetermined conditions, such as temperature, pressure, or the like. One or more sensors (not shown) can observe or detect the hydrocracking reaction conditions. The observed conditions can be compared to the set conditions and if the observed conditions exceed the set conditions, the kill agent can be released or introduced into the hydrocracking reactor 104. For example, the valve 208 can be opened automatically upon detection of an event indicating that an observed condition has exceeded a set condition.

FIG. 3 depicts a process schematic employing the hydrocracking reactor 104, according to one or more embodiments. More particularly, FIG. 3 shows a schematic of a Veba Combi-Cracking (VCC) process system 300 incorporating the hydrocracking reactor 104. As shown in FIG. 3, carbonaceous solids via line 302 and a heavy hydrocarbon via line 304 can be mixed, blended, or otherwise combined in mixer 306 to produce a slurry feed via line 308. The mixer 306 can include any device or apparatus capable of producing a slurry from a liquid feed and a solids-containing feed. The slurry feed via line 308 can then be combined with a hydrogen-containing gas via line 310 to the produce a hydrogen-containing slurry feed via line 312. The hydrogen-containing slurry feed via line 312 can be heated, for example via a heater 314, to produce a heated hydrogen-containing slurry feed via line 316. The heated hydrogen-containing slurry feed via line 316 can be introduced to a slurry-phase hydrocracker 318 to produce a first hydrocracked product via line 320. The first hydrocracked product via line 320 can then be introduced to one or more first separators 324 to remove one or more first light components via line 334 and one or more heavy components via line 326. The heavy components via line 326 can be introduced to one or more second separators 328 to remove one or more second light components via line 332 and a residue-containing stream via line 330. The first light components via line 334 and the second light components via line 332 can be combined to form the hydrocarbon feed via line 102 that can be delivered to the hydrocracking reactor 104.

The carbonaceous feedstock via line 302 can be or include one or more carbon-based and/or carbon-containing solid materials. The carbonaceous feedstock can include, but is not limited to, biomass (e.g., plant and/or animal matter or plant and/or animal derived matter); coal (including anthracite, bituminous, sub-bituminous and lignite); oil shale; coke; tar; asphaltenes; low ash or no ash polymers; hydrocarbon-based polymeric materials; biomass derived material; metal containing compounds, or by-product derived from manufacturing operations. The heavy hydrocarbon can include via line 304 can include C₂-C₅₀ hydrocarbons, C₂-C₄₀ hydrocarbons, C₃-C₃₀ hydrocarbons, or C₄-C₂₀ hydrocarbons. The hydrocarbon via line 304 can be one or more heavy and/or low value hydrocarbons. For example, the hydrocarbon via line 304 can include C₁₂+ hydrocarbons, such as C₁₂-C₅₀ hydrocarbons. The hydrocarbon via line 304 can include, but is not limited to, whole crude oil, crude oil, vacuum gas oil, heavy gas oil, residuum, atmospheric tower bottoms, vacuum tower bottoms, distillates, paraffins, aromatic rich material from solvent deasphalting units, visbroken resids, aromatic hydrocarbons, naphthenes, oil shales, oil sands, tars, bitumens, kerogen, coal liquids, waste oils, fractions thereof, derivatives thereof, and combinations thereof. The hydrogen-containing gas via line 310 can have a hydrogen concentration of about 90 mol % or more, about 95 mol % or more, about 99 mol % or more, or about 99.9 mol % or more. The hydrogen-containing gas can have a pressure of about 500 kPa, about 1,000 kPa, about 2,000 kPa, about 2,500 kPa, or about 5,000 kPa to about 7,500 kPa, about 10,000 kPa, about 15,000 kPa, about 25,000 kPa, or about 50,000 kPa.

The temperature of the heated hydrogen-containing slurry feed via line 316 can be about 200° C., about 250° C., about 300° C., or about 400° C. to about 500° C., about 600° C., about 750° C., about 850° C., or about 1,000° C. Heating the hydrocarbon within the heater 314 can vaporize at least a portion of the hydrocarbon, thereby increasing the pressure of the heated hydrogen-containing slurry feed via line 316 above the pressure of the hydrogen-containing slurry feed via line 312. The pressure of the heated hydrogen-containing slurry feed via line 316 can be about 750 kPa, about 1,500 kPa, about 3,000 kPa, about 3,500 kPa, or about 7,000 kPa to about 8,500 kPa, about 12,000 kPa, about 17,000 kPa, about 35,000 kPa, or about 50,000 kPa.

The heater 314 can include any system, device, or combination of systems and/or devices suitable for increasing the temperature of the hydrogen-containing slurry feed in line 312. Illustrative heat exchangers can include, but are not limited to shell-and-tube exchangers, plate and frame exchangers, spiral wound exchangers, or any combination thereof. In one or more embodiments, a heat transfer medium such as steam, hot oil, hot process fluids, electric resistance heat, hot waste fluids, or combinations thereof can be used to provide the necessary heat to the hydrogen-containing slurry feed in line 312. In one or more embodiments, the heater 314 can be a direct-fired heater, for example, a natural gas fired heater, or the equivalent.

The heater 314 can operate at a temperature of about 200° C., about 250° C., about 300° C., or about 400° C. to about 500° C., about 600° C., about 750° C., about 850° C., or about 1,000° C. The heater 314 can operate at a pressure of about 750 kPa, about 1,500 kPa, about 3,000 kPa, about 3,500 kPa, or about 7,000 kPa to about 8,500 kPa, about 12,000 kPa, about 17,000 kPa, about 35,000 kPa, or about 50,000 kPa.

The heated hydrogen-containing slurry feed via line 316 can be pumped or introduced to the slurry phase hydrocracker 318. The slurry phase hydrocracker 318 can be or include a vessel or tower that can be vertically oriented. For example, the heated hydrogen-containing slurry feed via line 316 can be pumped to a bottom end of the slurry phase hydrocracker 318. In the slurry phase hydrocracker 318, the hydrogen present in the heated hydrogen-containing slurry feed can react with the hydrocarbons present heated hydrogen-containing slurry feed. A first hydrocracked product via line 320 can be obtained from a top end of the slurry phase hydrocracker 318.

The first hydrocracked product via line 320 can be introduced to the first separator 324. The first separator 324 can include an operating pressure less than the pressure of the first hydrocracked product introduced thereto via line 320. The reduced pressure within the first separator 324 relative to the pressure of the first hydrocracked product in line 320 can promote the volatilization (“flashing”) of lighter hydrocarbons within the first separator 324. The operating pressure of the first separator 324 can be atmospheric pressure. An interior volume of the first separator 324 can be empty, partially filled, or completely filled with one or more fill materials (not shown). Illustrative fill materials can include, but are not limited to, trays, packing, or combinations thereof.

First separator 324 can separate the first hydrocracked product into at least the light components and the heavy components. The light components via line 334 can include, but are not limited to, naphtha, diesel, vacuum gas oil, or any mixture thereof. The heavy components via line 326 can include, but are not limited to, ash, vacuum residue, unconverted solids, heavy oils, metals, spent catalyst, pitch, or any mixture thereof. The first light components via line 334 can be mixed with one or more second light components via line 332 to form the hydrocarbon feed via line 102 that can be delivered to the hydrocracking reactor 104. The second light components can include, but are not limited to, naphtha, diesel, vacuum gas oil, or any mixture thereof. The second light components via line 332 can be obtained as an overhead resulting from separating the heavy components in line 326.

Embodiments of the present disclosure further relate to any one or more of the following paragraphs:

1. A method for idling a hydrocracking reactor, comprising: hydrocracking a hydrocarbon in the presence of a catalyst and hydrogen in a reactor to produce a hydrocracked product; and introducing a kill agent to the reactor in an amount sufficient to reduce hydrocracking by at least 10% therein.

2. The method according to paragraph 1, wherein the kill agent comprises a nitrogen-containing compound, and wherein the nitrogen-containing compound comprises ammonia, one or more amines, aniline, one or more ammonia-containing compounds, one or more amine-containing compounds, one or more aniline-containing compounds, or any mixture thereof.

3. The method according to any one of paragraphs 1 to 2, wherein the hydrocarbon comprises atmospheric residue, vacuum residue, crude oil, heavy oil, visbroken resid, tar, oil shale, oil sand, bitumen, waste oil, light oil, heavy oil, naphtha, vacuum gas oil, kerosene, diesel, coal, or any mixture thereof.

4. The method according to any one of paragraphs 1 to 3, wherein the hydrogen is introduced to the reactor as a gas mixture comprising a concentration of the hydrogen of about 50 vol % or greater.

5. The method according to any one of paragraphs 1 to 4, wherein the catalyst comprises a zeolite and a Group VIII metal.

6. The method according to any one of paragraphs 1 to 5, wherein the catalyst comprises one or more Group VIII metals, one or more Group VIB metals, and a catalyst support, wherein the one or more Group VIII metals comprises cobalt, nickel, palladium, iron, alloys thereof, or combinations thereof, wherein the one or more Group VIB metals comprises molybdenum, tungsten, alloys thereof, oxides thereof, or combinations thereof.

7. The method according to any one of paragraphs 1 to 6, wherein the kill agent is mixed with a quench gas prior to being introduced to the reactor.

8. The method according to any one of paragraphs 1 to 7, wherein the hydrocarbon is hydrocracked at a temperature of about 250° C. to about 500° C. within the reactor, and wherein introducing the kill agent to the reactor is sufficient to reduce hydrocracking by at least 90% therein.

9. The method according to any one of paragraphs 1 to 8, wherein the kill agent is introduced to the reactor in an amount of about 1 wt % to about 50 wt %, based on a total weight of the catalyst in the reactor.

10. The method according to any one of paragraphs 1 to 9, further comprising: stopping introduction of the kill agent to the reactor; reducing a concentration of the kill agent in the reactor; reintroducing the hydrocarbon and the hydrogen to the reactor; and resuming the hydrocracking of the hydrocarbon.

11. The method according to paragraphs 1, wherein the hydrocarbon comprises atmospheric residue, vacuum residue, crude oil, heavy oil, visbroken resid, tar, oil shale, oil sand, bitumen, waste oil, light oil, heavy oil, naphtha, vacuum gas oil, kerosene, diesel, coal, or any mixture thereof, wherein the kill agent comprises a nitrogen-containing compound, and the nitrogen-containing compound comprises ammonia, one or more amines, aniline, one or more ammonia-containing compounds, one or more amine-containing compounds, one or more aniline-containing compounds, or any mixture thereof, wherein the catalyst comprises one or more Group VIII metals, one or more Group VIB metals, and a catalyst support, wherein the one or more Group VIII metals comprises cobalt, nickel, palladium, iron, alloys thereof, or combinations thereof, wherein the one or more Group VIB metals comprises molybdenum, tungsten, alloys thereof, oxides thereof, or combinations thereof, wherein the hydrogen is introduced to the reactor as a gas mixture comprising a concentration of the hydrogen of about 50 vol % or greater, and wherein the hydrocarbon is hydrocracked at a temperature of about 250° C. to about 500° C. within the reactor, and wherein introducing the kill agent to the reactor is sufficient to reduce hydrocracking by at least 90% therein.

12. A method for idling a hydrocracking reactor, comprising: introducing a hydrocarbon and hydrogen to a reactor; reacting the hydrocarbon and the hydrogen in the presence of a hydrocracking catalyst to obtain a hydrocracked product; introducing a quench gas comprising hydrogen to the reactor from one or more quench lines coupled to the reactor; mixing a nitrogen-containing compound with the quench gas in the one or more quench lines; introducing the nitrogen-containing compound and the quench gas to the reactor in an amount sufficient to reduce hydrocracking by at least 90% therein; and stopping reaction of the hydrocarbon and the hydrogen-containing gas after introduction of the nitrogen-containing compound to the reactor.

13. The method according to paragraph 11, wherein the nitrogen-containing compound comprises ammonia, one or more amines, aniline, any ammonia-containing compounds, any amine-containing compounds, any aniline-containing compounds, or any mixture thereof.

14. The method according to paragraphs 11 or 12, wherein the hydrocarbon comprises atmospheric residue, vacuum residue, crude oils, heavy oils, visbroken resids, tars, coal liquids, oil shales, oil sands, bitumens, waste oils light oil, heavy oil, naphtha, vacuum gas oil, kerosene, diesel, coal, or any mixture thereof.

15. The method according to any one of paragraphs 11 to 13, wherein introducing the nitrogen-containing compound and the quench gas to the reactor is sufficient to stop hydrocracking therein.

16. The method according to any one of paragraphs 11 to 14, wherein reaction of the hydrocarbon and the hydrogen in the presence of a hydrocracking catalyst occurs at a temperature of about 250° C. to about 500° C.

17. The method according to any one of paragraphs 11 to 15, wherein the nitrogen-containing compound is introduced to the reactor in an amount of about 1 wt % to about 50 wt %, based on a total weight of the hydrocracking catalyst in the reactor.

18. The method according to any one of paragraphs 11 to 16, wherein the nitrogen-containing compound is mixed with the quench gas in response to a temperature in the reactor exceeding a set condition.

19. A system for idling a hydrocracking reaction, comprising: a hydrocracker adapted to receive a hydrocarbon and hydrogen, the hydrocracker comprising one or more beds of hydrocracking catalyst; one or more quench lines coupled to a sidewall of the hydrocracker, each quench line coupled to the sidewall at a location proximate a bed of the hydrocracking catalyst and adapted to receive a quench gas comprising hydrogen; and a vessel adapted to store a kill agent, wherein the vessel is in fluid communication with the one or more quench lines.

20. The system according to paragraph 19, further comprising: a valve fluidly coupled between the vessel and the one or more quench lines, wherein the valve is adapted to introduce the kill agent and the quench gas to the reactor in an amount sufficient to stop hydrocracking therein upon opening of the valve; a secondary quench line coupled to a top of the vessel and adapted to carry quench gas from a quench line to the top of the vessel; and one or more sensors coupled to the hydrocracker and adapted to transmit one or more signals to a control system, wherein the valve is adapted to open in response to the one or more signals received by the control system.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for idling a hydrocracking reactor, comprising:
hydrocracking a hydrocarbon in the presence of a catalyst and hydrogen in a reactor to produce a hydrocracked product; and
introducing a kill agent to the reactor in an amount sufficient to reduce hydrocracking by at least 10% therein.

2. The method of claim 1, wherein the kill agent comprises a nitrogen-containing compound, and wherein the nitrogen-containing compound comprises ammonia, one or more amines, aniline, one or more ammonia-containing compounds, one or more amine-containing compounds, one or more aniline-containing compounds, or any mixture thereof.

3. The method of claim 1, wherein the hydrocarbon comprises atmospheric residue, vacuum residue, crude oil, heavy oil, visbroken resid, tar, oil shale, oil sand, bitumen, waste oil, light oil, heavy oil, naphtha, vacuum gas oil, kerosene, diesel, coal, or any mixture thereof.

4. The method of claim 1, wherein the hydrogen is introduced to the reactor as a gas mixture comprising a concentration of the hydrogen of about 50 vol % or greater.

5. The method of claim 1, wherein the catalyst comprises a zeolite and one or more Group VIII metals.

6. The method of claim 1, wherein the catalyst comprises one or more Group VIII metals, one or more Group VIB metals, and a catalyst support, wherein the one or more Group VIII metals comprises cobalt, nickel, palladium, iron, alloys thereof, or combinations thereof, wherein the one or more Group VIB metals comprises molybdenum, tungsten, alloys thereof, oxides thereof, or combinations thereof.

7. The method of claim 1, wherein the kill agent is mixed with a quench gas prior to being introduced to the reactor.

8. The method of claim 1, wherein the hydrocarbon is hydrocracked at a temperature of about 250° C. to about 500° C. within the reactor, and wherein introducing the kill agent to the reactor is sufficient to reduce hydrocracking by at least 90% therein.

9. The method of claim 1, wherein the kill agent is introduced to the reactor in an amount of about 1 wt % to about 50 wt %, based on a total weight of the catalyst in the reactor.

10. The method of claim 1, further comprising:
stopping introduction of the kill agent to the reactor;
reducing a concentration of the kill agent in the reactor;
reintroducing the hydrocarbon and the hydrogen to the reactor; and
resuming the hydrocracking of the hydrocarbon.

11. The method of claim 1, wherein the hydrocarbon comprises atmospheric residue, vacuum residue, crude oil, heavy oil, visbroken resid, tar, oil shale, oil sand, bitumen, waste oil, light oil, heavy oil, naphtha, vacuum gas oil, kerosene, diesel, coal, or any mixture thereof, wherein the kill agent comprises a nitrogen-containing compound, and the nitrogen-containing compound comprises ammonia, one or more amines, aniline, one or more ammonia-containing compounds, one or more amine-containing compounds, one or more aniline-containing compounds, or any mixture thereof, wherein the catalyst comprises one or more Group VIII metals, one or more Group VIB metals, and a catalyst support, wherein the one or more Group VIII metals comprises cobalt, nickel, palladium, iron, alloys thereof, or combinations thereof, wherein the one or more Group VIB metals comprises molybdenum, tungsten, alloys thereof, oxides thereof, or combinations thereof, wherein the hydrogen is introduced to the reactor as a gas mixture comprising a concentration of the hydrogen of about 50 vol % or greater, and wherein the hydrocarbon is hydrocracked at a temperature of about 250° C. to about 500° C. within the reactor, and wherein introducing the kill agent to the reactor is sufficient to reduce hydrocracking by at least 90% therein.

12. A method for idling a hydrocracking reactor, comprising:
introducing a hydrocarbon and hydrogen to a reactor;
reacting the hydrocarbon and the hydrogen in the presence of a hydrocracking catalyst to obtain a hydrocracked product;
introducing a quench gas comprising hydrogen to the reactor from one or more quench lines coupled to the reactor;
mixing a nitrogen-containing compound with the quench gas in the one or more quench lines;
introducing the nitrogen-containing compound and the quench gas to the reactor in an amount sufficient to reduce hydrocracking by at least 90% therein; and
stopping reaction of the hydrocarbon and the hydrogen-containing gas after introduction of the nitrogen-containing compound to the reactor.

13. The method of claim 12, wherein the nitrogen-containing compound comprises ammonia, one or more amines, aniline, any ammonia-containing compounds, any amine-containing compounds, any aniline-containing compounds, or any mixture thereof.

14. The method of claim 12, wherein the hydrocarbon comprises atmospheric residue, vacuum residue, crude oils, heavy oils, visbroken resids, tars, coal liquids, oil shales, oil sands, bitumens, waste oils light oil, heavy oil, naphtha, vacuum gas oil, kerosene, diesel, coal, or any mixture thereof.

15. The method of claim 12, wherein introducing the nitrogen-containing compound and the quench gas to the reactor is sufficient to stop hydrocracking therein.

16. The method of claim 12, wherein reaction of the hydrocarbon and the hydrogen in the presence of a hydrocracking catalyst occurs at a temperature of about 250° C. to about 500° C.

17. The method of claim 12, wherein the nitrogen-containing compound is introduced to the reactor in an amount of about 1 wt % to about 50 wt %, based on a total weight of the hydrocracking catalyst in the reactor.

18. The method of claim 12, wherein the nitrogen-containing compound is mixed with the quench gas in response to a temperature in the reactor exceeding a set condition.

19. A system for idling a hydrocracking reaction, comprising:
a hydrocracker adapted to receive a hydrocarbon and hydrogen, the hydrocracker comprising one or more beds of hydrocracking catalyst;
one or more quench lines coupled to a sidewall of the hydrocracker, each quench line coupled to the sidewall at a location proximate a bed of the hydrocracking catalyst and adapted to receive a quench gas comprising hydrogen; and
a vessel adapted to store a kill agent, wherein the vessel is in fluid communication with the one or more quench lines.

20. The system of claim 19, further comprising:
a valve fluidly coupled between the vessel and the one or more quench lines, wherein the valve is adapted to introduce the kill agent and the quench gas to the reactor in an amount sufficient to stop hydrocracking therein upon opening of the valve;
a secondary quench line coupled to a top of the vessel and adapted to carry quench gas from a quench line to the top of the vessel; and
one or more sensors coupled to the hydrocracker and adapted to transmit one or more signals to a control system, wherein the valve is adapted to open in response to the one or more signals received by the control system.
